(19) United States
(12) Patent Application Publication
(10) Pub. No.: US 2005/0276287 A1
(43) Pub. Date: Dec. 15, 2005

(54) Tunable laser light apparatus

(76) Inventor: Marc Epitaux, Sunnyvale, CA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/857,097

(22) Filed: May 28, 2004

(51) Int. Cl. H01S 3/10

(52) U.S. Cl. 372/20

(57) ABSTRACT

A tunable laser light apparatus having one or more optoelectronic devices hosting a number of selectively activatable light outputting sources, and an integrally packaged movable lens, is described herein.

### FIELD OF THE INVENTION

The present invention relates generally to the field of laser devices.

### BACKGROUND OF THE INVENTION

Laser light producing devices (hereinafter, simply laser devices) are commonly employed in communication applications. In particular, distributed feedback (DFB) laser devices are commonly employed in wavelength division multiplexing (WDM) systems. Typically, depending on the applications, DFB laser devices of different wavelengths are required. Historically, different parts designed for different wavelengths are manufactured and stocked to meet the different wavelength needs. The approach is inefficient and costly.

More recently, attempts have been made to manufacture tunable DFB laser devices that support multiple wavelengths. Typically, these tuner laser devices include laser stripes configured to generate laser light of different wavelengths. Further, a passive combiner is integrated to combine the outputs of the laser stripes. To generate a laser light of a desired wavelength, appropriate selected one or ones of the laser stripes are electrically activated.

However, passive combiners are known to have an intrinsic minimum loss that increases with the number of laser stripes integrated with the laser device. Thus, it is difficult to implement such a device to support a wide range of wavelengths. Further, the approach increases the real estate requirement of the laser devices, and decreases manufacturing yield (due to the added complexity from integrating the passive elements).

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a partially cut-away perspective view of a laser device, in accordance with an embodiment of the present invention;

FIG. 2 illustrates a cross sectional view of the laser device FIG. 1;

FIGS. 3a-3b illustrate the operational principles of the laser device of FIG. 1;

FIGS. 4a-4b illustrate a top view of the MEMS with a movable lens of FIG. 1 and a zoom in view of a portion of one of the comb drives respectively, and

FIG. 5 illustrates an example system having the laser device of FIG. 1, in accordance with one embodiment.

### DETAILED DESCRIPTION OF ILLUSTRATIVE EMBODIMENTS

Illustrative embodiments of the present invention include, but are not limited to, a laser device, and system having such a laser device.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

The phrase “in one embodiment” is used repeatedly. The phrase generally does not refer to the same embodiment; however, it may. The terms “comprising”, “having” and “including” are synonymous, unless the context dictates otherwise.

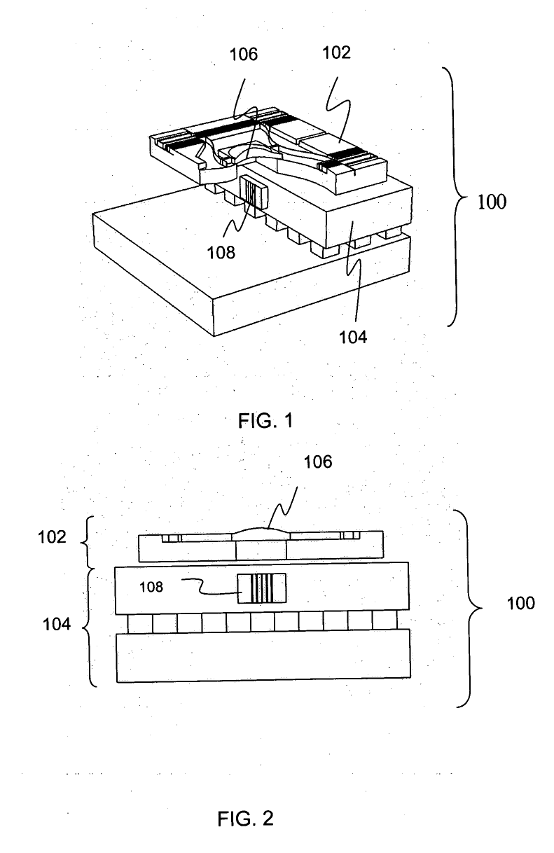

Referring now to FIGS. 1-2, wherein a partially cut-away perspective view and a side view of a laser device are shown, respectively, in accordance with one embodiment of the present invention. As illustrated, for the embodiment, laser device 100 includes laser stripes 108 attached to thermal electric cooler (TEC) 104, and micro electromechanical system (MEMS) 102 having moveable lens 106, disposed relatively to each other as shown.

Laser stripes 108 include a number of stripes, one or more of which can be selectively activated to facilitate production of laser light for a desired wavelength. Together, they (with the assistance of MEMS 102) enable laser light of a selected one of a wide range of wavelengths to be selectively produced. Resultantly, for a given desired range of selectable wavelength (and other factors, such as volume and overhead cost, being equal), a relatively lower cost tunable laser device may be produced.

In various embodiments, each stripe or group of stripes are further designed such that when they are activated to produce laser light of a desired wavelength, the wavelength of the laser light outputted may be further fine tuned by controlling the thermal condition of the optoelectronic device hosting the activated laser stripe or stripes. In various embodiments, one or more optoelectronic devices may be employed to host laser stripes 108. Selection of the one or more stripes, including controlling of the thermal condition of the optoelectronic device hosting the activated laser stripe or stripes may be effectuated via any one of a number of techniques.

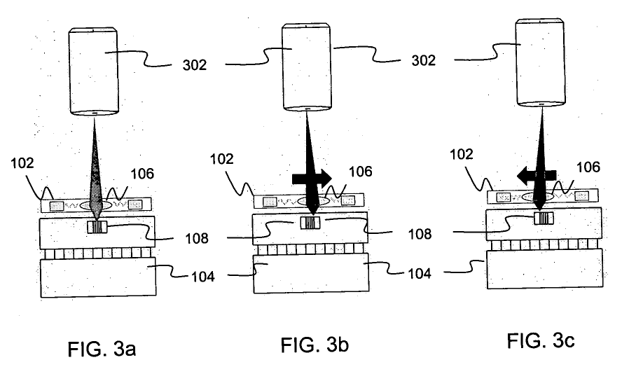

MEMS 102 is designed such that lens 106 may be electromechanically moved at least in either direction along the X-axis (as illustrated by FIG. 3a-3c) to appropriately align lens 106 with the activated laser stripes, to focus the laser light outputted to an output medium 302, e.g. a fiber. In various embodiments, movement along a selected one of the Y and −Y directions may also be optionally effectuated, substantially at the same time, when effectuating movement along the X/−X direction.

In various embodiments, to accommodate manufacturing tolerance, MEMS 102 is further designed such that lens 106 may also be electromechanically moved in either direction along the Y-axis to appropriately align lens 106 with the activated laser stripes, to focus the laser light outputted to an output medium. In various embodiments, movement along a selected one of the X and −X directions may also be optionally effectuated, substantially at the same time, when effectuating movement along the Y/−Y direction.

The ability for lens 106 to be moved in 1 or 2 directions may be effectuated by providing a number of movable elements to MEMS 102, attaching these movable elements to lens 106 to move it in the desired X (and/or Y) direction(s).

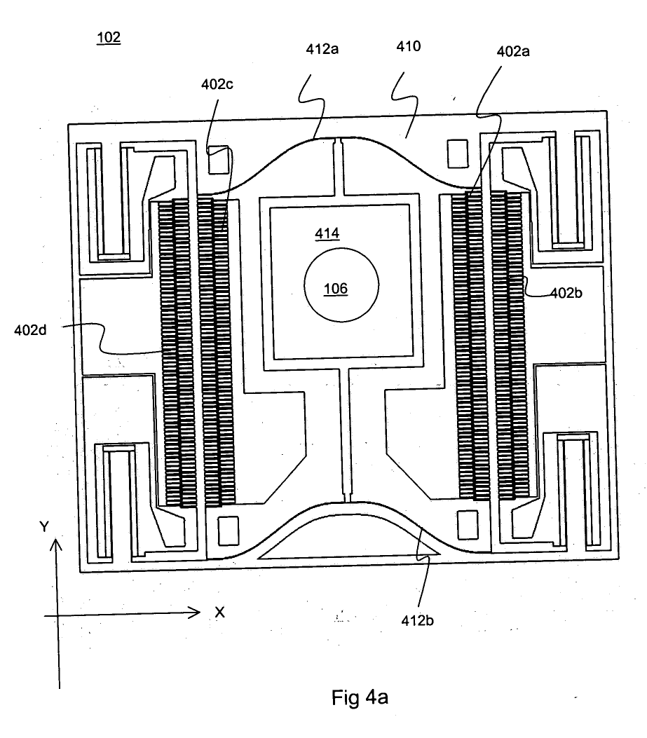

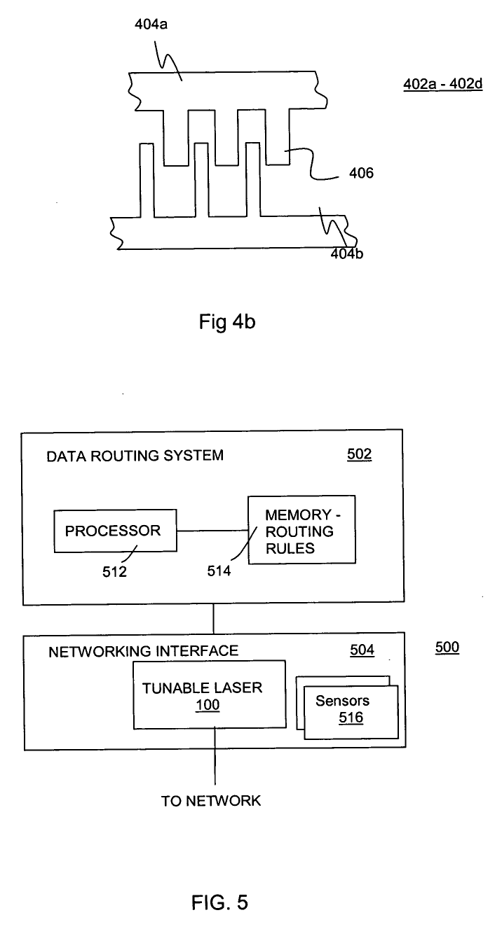

Referring now also to FIGS. 4a-4b, wherein a top view of a MEMS drive mechanism and a zoom in view of one of the comb drives, in accordance with one embodiment, are shown, respectively. As illustrated, for the embodiment, MEMS 102 is provided with a number of micro drives 402a, 402b, 402c, and 402d. Comb drives 402a-402b and 402c-402d are disposed on opposite sides of the substrate. Further, the comb drives 402a, 402b, 402cb, and 402d are attached to two compliant suspension beams 412a-412b, which in turn are operatively coupled to lens 106, to enable MEMS 102 to be able to provide the desired electromechanical X (and Y) movements of lens 106. In various embodiments, lens 106 is disposed on a stage 414, which is in turn attached to compliant suspension beams 412a-412b.

References to the edges of MEMS 102 as “top”, “bottom” and “side” are for ease of understanding, and should not be read as limiting to embodiments of the invention. The edges could have been referenced in other manners if MEMS 102 is described from another point of view.

Still referring to FIGS. 4a-4b, more specifically, for the embodiment, each of the micro drives 402a, 402b, 402c, and 402d is a comb drive comprising two portions 404a-404b, of which one portion is substantially “fixed” to the substrate, and the other portion is attached to one end of one the compliant suspension beams 412a-412b. In various embodiments, the portion substantially “fixed” to the substrate, may be designed to be “fixed” to the substrate by way of one or more springs (not shown). Further, as illustrated, each portion 404a-404b has a number of fingers (406 of FIG. 4b), and the portions 404a-404b operate in accordance with electrostatic principles. That is, when the portions 404a-404b are activated (energized) complementarily, the portion 404a/404b attached to one end of the complaint suspension beam 412a/412b moves towards or away from the portion 404b/404a substantially “fixed” to the substrate. Thus, the former portion may be referred to as the movable portion, whereas the latter portion may be referred to as a “fixed” portion.

In various embodiments, comb drives 402a, 402b, 402c, and 402d may be selectively activated in combination with variable intensities, that are the same or different from each other, to provide movement in one or two directions. The amount of movement in each of the directions is dependent on the intensity levels of activation, and the relative difference between the selected comb drives being activated in combination.

In alternate embodiments, the present invention may be practiced with other other drive arrangements of the like.

Thus, operationally, to effectuate output of a laser light of a desired wavelength, one or more appropriate ones of the laser stripes 108 are activated to produce light with a wavelength in the neighborhood of the desired wavelength. The operation may also be referred to as coarse selection. Thereafter, the activated laser stripes 108 may be thermally controlled to provide the laser light of the desired wavelength. The operation may also be referred to as fine tuning of the laser light outputting.

Thereafter, before, or substantially concurrent with the above described coarse and fine tuning operations, lens 106 may be moved such that it is positioned properly to optically couple the laser light output onto an output medium, e.g. a fiber.

Accordingly, a more cost effective tunable laser device may be produced.

FIG. 5 illustrates an example communication system, in accordance with one embodiment. As illustrated, example system 500 includes data routing subsystem 502 and network interface module 504 coupled to each other as shown. Network interface module 504 is employed to optically coupled communication system 500 to a network, which may be a local area network, a wide area network, a telephone network, and so forth. These networks may be private and/or public. For the embodiment, network interface module 504 includes in particular, laser device 100 of FIG. 1. For the purpose this specification, network interface module 504 may also be referred to as a communication interface.

Still referring to FIG. 5, for the embodiment, data routing subsystem 502 includes processor 512 and memory 514 coupled to each other as shown. Memory 514 has stored therein a number of data routing rules, according to which processor 512 routes data received through networking interface 504. The data routing rules may be stored employing any one of a number of data structure techniques, including but are not limited to e.g. tables, link lists, and so forth. The data may be received and forwarded in accordance with any one of a number of communication protocols, including but are not limited to e.g. the Transmission Control Protocol/Internet Protocol (TCP/IP).

In various embodiments, the tasks performed by processor 512 may include controlling the earlier described selective activation of laser stripes 108, their fine tuning, and moving of lens 106. In alternate embodiments, the actual controlling may be delegated to one or more other controllers (not shown). That is, processor 512 effectuates the desired controls via these other controllers. Accordingly, for the claims, a processor may be referred to as a controller or vice versa, i.e. the terms are to be considered interchangeable.

Further, in various embodiments, data routing system 502 may also include one or more sensors (516) to collect one or more performance metrics on laser device 100, e.g. the wavelength and the power of outputted laser light, temperatures of one or more locations, and so forth. The sensors may also be coupled to processor 512 (or its agents, the “downstream” controllers, if applicable), to effectuate their controls (periodically or in real time), further in view of the data collected for the performance metrics. In various embodiments, at least some of the sensors are disposed outside network interface module 504.

Except for the incorporation of laser device 100 with network interface module 504, elements 502-504 represent a broad range of these elements known in the art or to be designed

In various embodiments, example system 500 may be a router, a switch, a gateway, a server, and so forth.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

1. An apparatus comprising:
one or more optoelectronic devices having a plurality of light outputting sources, selectively activatable, to facilitate output of a laser light with a desired wavelength of a wavelength range; and
an electromechanical system integrally packaged with the one or more optoelectronic devices, the electromechanical system including a lens that is electromechanically movable to be optically coupled with the selectively activated one(s) of the light outputting sources to facilitate said output of the laser light with the desired wavelength of a wavelength range.

2. The apparatus of claim 1, wherein each of the plurality of light outputting sources of the one or more optoelectronic devices is equipped to output laser light for a subset of the wavelength range.

3. The apparatus of claim 1,wherein at least one of the plurality of light outputting sources of the one or more optoelectronic devices comprises a laser stripe.

4. The apparatus of claim 1, wherein the one or more optoelectronic devices are controllable to fine tune the wavelength of the laser light outputted by the selected light outputting source, within a subset of the wavelength range.

5. The apparatus of claim 4,wherein the selected light outputting source of the one or more optoelectronic devices comprises a laser stripe, which outputted laser light's wavelength can be fine tuned by adjusting a thermal condition of the optoelectronic device comprising the laser stripe.

6. The apparatus of claim 1, wherein the apparatus further comprises a thermal electric cooler, with which the one or more optoelectronic devices are attached, to cool the one or more optoelectronic devices.

7. The apparatus of claim 1, wherein the apparatus further comprises one or more controllers coupled to the one or more optoelectronic devices to make said selection of the light outputting devices.

8. The apparatus of claim 1, wherein the apparatus further comprises one or more controllers coupled to the electromechanical system to control said moving of the lens.

9. The apparatus of claim 1, wherein the lens are movable in at least either direction along at least two substantially orthogonal axes.

10. The apparatus of claim 1, wherein the lens are movable in a first direction along a first of the orthogonal axes, and a second direction along a second of the orthogonal axes in substantially the same time.

11. The apparatus of claim 1, wherein the apparatus further comprises a sensor to monitor the outputted laser light for at least a selected one of power and wavelength, and the controller is further coupled to the sensor, and performs said control of the moving of the lens, based at least in part on the result of said monitoring.

12. A method comprising:
selecting one of a plurality of light outputting sources of one or more optoelectronic devices for use to output a laser light of a desired wavelength of a wavelength range; and
moving a lens of a electromechanical system integrally packaged with the one or more optoelectronic devices to be optically coupled with the selected one(s) of the light outputting sources of the one or more optoelectronic devices to facilitate the outputting of the laser of the desired wavelength in the wavelength range.

13. The method of claim 12, wherein each of the plurality of light outputting sources of the one or more optoelectronic devices is equipped to output laser light for a subset of the wavelength range.

14. The method of claim 12, wherein at least one of the plurality of light outputting sources of the one or more optoelectronic devices comprises a laser stripe.

15. The method of claim 12, wherein the method further comprises fine tuning the wavelength of the laser light outputted by a selected one of the light outputting sources of the one or more optoelectronic devices.

16. The method of claim 15, wherein the selected light outputting source of the one or more optoelectronic devices comprises a laser stripe, and said fine tuning comprises adjusting a thermal condition of the optoelectronic device comprising the laser stripe.

17. The method of claim 12, wherein said moving comprises moving the lens in a first direction, and a second direction that is substantially orthogonal to the first direction.

18. The method of claim 11, wherein the method further comprises cooling the one or more optoelectronic devices with a thermal electric cooler, with which the one or more optoelectronic devices are attached.

19. The method of claim 11, wherein the method further comprises monitoring the outputted laser light for at least a selected one of power and wavelength, and performing said moving of the lens, based at least in part on the result of said monitoring.

20. A system comprising:
a data routing subsystem including memory having a plurality of data routing rules, and a processor coupled to the memory to route data based at least in part on the data routing rules; and
a network interface module coupled to the data routing subsystem to optically forward data for the data routing subsystem, the network interface module including
one or more optoelectronic devices having a plurality of light outputting sources selectable to facilitate outputting of a laser light with a desired wavelength in a wavelength range, and
an electromechanical system integrally packaged with the one or more optoelectronic devices, the electromechnical system including a lens that is electromechanically movable to be optically coupled with the selected one(s) of the light outputting sources to facilitate said outputting of the laser light with the desired wavelength within the wavelength range.

21. The system of claim 20, wherein each of the plurality of light outputting sources of the one or more optoelectronic devices is equipped to output laser light for a subset of the wavelength range.

22. The system of claim 19, wherein at least one of the plurality of light outputting sources of the one or more optoelectronic devices comprises a laser stripe.

23. The system of claim 20, wherein the one or more optoelectronic devices are controllable to fine tune the wavelength of the laser light outputted by the selected light outputting source, within a subset of the wavelength range.

24. The system of claim 20, wherein the selected light outputting source of the one or more optoelectronic devices comprises a laser stripe, which outputted laser light's wavelength can be fine tuned by adjusting a thermal condition of the optoelectronic device comprising the laser stripe.

25. The system of claim 20, wherein the lens is movable in either direction along two substantially orthogonal axes.
